(19) United States
(12) Patent Application Publication
(10) Pub. No.: US 2006/0187794 A1
(43) Pub. Date: Aug. 24, 2006

(54) Uses of wave guided miniature holographic system

(76) Inventors: Tim Harvey, Fairfax, VA (US); Steve Redfield, Falls Church, VA (US); Kismine Starr, Santa Fe, NM (US)

Correspondence Address: HOWISON & ARNOTT, L.L.P, P.O. BOX 741715, DALLAS, TX, 75374-1715, US

(21) Appl. No.: 11/251,574

(22) Filed: Oct. 14, 2005

Related U.S. Application Data
(60) Provisional application No. 60/618,921, filed on Oct. 14, 2004.
(60) Provisional application No. 60/618,917, filed on Oct. 14, 2004.
(60) Provisional application No. 60/618,916, filed on Oct. 14, 2004.

(51) Int. Cl. G11B 7/00

(52) U.S. Cl. 369/103

(57) ABSTRACT

A holographic memory device for use in a personal electronic device is disclosed. The device contains a holographic data storage media adapted to store a data pattern associated with a data beam. The device has capability for reading and writing to the holographic data storage media. The device contains a personal electronics device interface for receiving data from and providing data to a host personal electronics device. The device reads and writes data to the holographic data storage media in response to requests received via the personal electronics device interface.

### CROSS REFERENCE TO RELATED APPLICATIONS

This application claims the benefit of: U.S. Provisional Application No. 60/618,921, filed Oct. 14, 2004, titled “USES OF WAVE GUIDED MINIATURE HOLOGRAPHIC SYSTEM,” U.S. Provisional Application No. 60/618,917, filed Oct. 14, 2004, titled “MINIATURE GUIDED WAVELENGTH MULTIPLEXED HOLOGRAPHIC STORAGE SYSTEM,” and U.S. Provisional Application No. 60/618,916, filed Oct. 14, 2004, titled “BRANCH PHOTOCYCLE TECHNIQUE FOR HOLOGRAPHIC RECORDING IN BACTERIORHODOPSIN, which are hereby incorporated by reference.” This application is related to, and is being filed concurrently with, U.S. patent application Ser. No. 11/251,576, titled “MINIATURE GUIDED WAVELENGTH MULTIPLEXED HOLOGRAPHIC STORAGE SYSTEM,” to be assigned to Starzent, Inc. of Fairfax Va. and U.S. patent application Ser. No. 11/251,575, titled “BRANCH PHOTOCYCLE TECHNIQUE FOR HOLOGRAPHIC RECORDING IN BACTERIORHODOPSIN,” to be assigned to Starzent, Inc. of Fairfax Va., which are hereby incorporated by reference.

### TECHNICAL FIELD OF THE INVENTION

This invention is related to Mass Storage Systems for Digital Data.

### BACKGROUND OF THE INVENTION

Holographic Storage, being a 3D recording technology, offers storage density advantages over traditional 2D recording technologies. There are generally two distinct types of approaches with regard to the medium types for various system architectures, which are fixed medium or movable medium (of which rotating is currently in widespread use for both holographic storage systems and magnetic disk drives). With the continued push for miniaturization of electronic devices particularly consumer devices, such as mass storage for cameras, programmable digital assistants (PDAs), digital music players such as the iPod or iPod Photo from Apple Computer of Cupertino, Calif., and other handheld devices, there is added incentive for smaller size, high capacity mass storage systems. Holographic storage systems have long been touted as technology for extremely high capacity mass storage however it has never really seen a niche for very small consumer devices because medium access approaches in general may require significant space or volume. Holographic rotating medium systems employ a motor that rotates the holographic medium similar to magnetic disk drives as illustrated in FIG. 1. In addition to the size disadvantage of using a motor to spin the medium, the accompanying optics are often large for a high capacity system, hence that approach typically targets the larger system equipment markets with drive bays in desk side PC towers and larger archive systems. Another disadvantage of rotating medium is the delay for accessing the data, which limits usefulness in many high data rate, transaction based applications. Access times for rotating holographic drives often are in the 100-200 ms regime.

Many holographic systems, with fixed media, use angle encoding to multiplex the different recorded data images or pages. The angle multiplexing requires beam deflection, which requires a standoff distance between the optics and medium. The resulting system has a large form factor and the beam deflection typically requires moving parts, such as galvanometers or other beam deflecting components and similar to the rotating medium systems inherently results in a corresponding delay in access time, although it may be on the order of a few milliseconds to 10s of milliseconds.

Most holographic systems (rotating and fixed medium) access the medium perpendicular to the face with the largest surface area. That approach inherently creates the need to place many optical components above the medium face and therefore slim or thin form factors become difficult. Packaging efficiencies are often less than 10% for such approaches.

In rotating medium architectures, capacity scaling by either increasing the medium diameter or thickness, both may slow down the access rate due to increased weight, which also requires increased power dissipation and may slow the initial boot up when bringing the rotating disk up to proper rotational speed.

Rotating medium systems may increase disk size to scale capacity but such scaling has a negative performance impact on power dissipation, the number of accesses per second, latency of the access because of the required motion of both the medium and optical head reading radial across tracks.

Therefore what is needed is a system and method to address the above, and related issues.

### SUMMARY OF THE INVENTION

The present invention disclosed and claimed herein, in one aspect thereof, comprises a holographic memory device for use in a personal electronic device. The memory device contains a holographic data storage media adapted to store a data pattern associated with a data beam, means for reading and writing to the holographic data storage media personal electronics device, and a personal electronics device interface for receiving data from and providing data to a host personal electronics device. The means for reading and writing reads and writes data to the holographic data storage media in response to requests received via the personal electronics device interface.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a conventional holographic drive with a rotating medium;

FIG. 2 illustrates a concept light entering a holographic medium from the edge of the medium;

FIG. 3 illustrates one example of the space required by angle multiplexing is shown;

FIG. 4 illustrates a compact holographic device without a rotating medium;

FIGS. 5a and 5b illustrate a chip-based memory embodiment that implementing various multiplexing schemes with a fixed medium;

FIG. 6 illustrates another compact holographic device with fixed medium;

FIG. 7 illustrates a holographic data storage engine;

FIGS. 8a and 8b illustrate one embodiment of a holographic data storage system;

FIGS. 9a and 9b illustrate holographic device mounting options;

FIG. 10 illustrates a Universal Serial Bus holographic memory device;

FIGS. 11a, 11b, and 11c illustrate a holographic memory device in a personal computer;

FIG. 12 illustrates a holographic memory that fits a standard DRAM socket;

FIGS. 13A-B illustrate a holographic memory in a PC motherboard;

FIGS. 14a, 14b, and 14c illustrate a holographic memory in a laptop computer;

FIGS. 15a, 15b, and 15c illustrate various embodiments of holographic media;

FIG. 16 illustrates an optical rail assembly with a holographic medium;

FIG. 17 illustrates a holographic memory as a part of a television entertainment center; and

FIGS. 18a, 18b, and 18c illustrate a holographic memory as part of a microcontroller.

### DETAILED DESCRIPTION OF THE INVENTION

Referring now to the drawings, views and embodiments of the present invention are illustrated and described, and other possible embodiments of the present invention are described. The figures are not necessarily drawn to scale, and in some instances the drawings have been exaggerated and/or simplified in places for illustrative purposes only. Additionally, like reference numerals do not necessarily reflect like components from one drawing to another. One of ordinary skill in the art will appreciate the many possible applications and variations of the present invention based on the following examples of possible embodiments of the present invention.

The present disclosure, in one aspect thereof, contemplates a collection of uses or applications for a very small holographic storage system architecture that has no moving parts, that utilizes millimeter sized optical channels to direct the reference beams and object beams (data image carrying beam) to the appropriate recording site for beam routing, and that does the hologram multiplexing by changing the wavelength of the light with a high resolution, narrow line tunable laser. This entire data storage system can be on the order of the size of a postage stamp. The system can also scale to larger sizes to increase capacity by increasing media volume in either the x, y or z dimension. The ability to scale volume by increasing any of the above dimensions creates significant packaging efficiency for many applications. When increasing the x, y, z dimension of the media, the packaging efficiency improves (the packaging overhead decreases). In a given application or use, the x, y, z dimension may be adjusted to efficiently utilize the space available therefore providing maximum data storage capability. Capacity may range from Gigabytes to Terabytes in specific embodiments.

The present disclosure contemplates a system that can scale up in capacity and size (in any or all of three dimensions), while maintaining speed performance, have a slim package that can utilize industry standard high volume, surface mount packaging equipment to place embodiments of the invention onto circuit cards while providing the performance benefits of holographic storage; high capacity, high speed at a high access rate.

Embodiments of this invention greatly reduce the size of a Holographic Storage system by utilizing switched, guide beam routing and wavelength multiplexing. The resulting small size enables a number of uses. These use bring high capacity, fast access (sub-millisecond to microseconds eventually nanoseconds, limited by laser tuning speed and power, not mechanical movement of device structure) mass memory into small systems, consumer devices and into lower levels of a computer memory hierarchy. The resulting volumetric packaging efficiency may be 60-80% in specific embodiments of this invention, whereas other holographic alternatives packaging efficiencies often are less than 10% (ratio of storage media volume to total package volume including electronics, optical and other mechanical components).

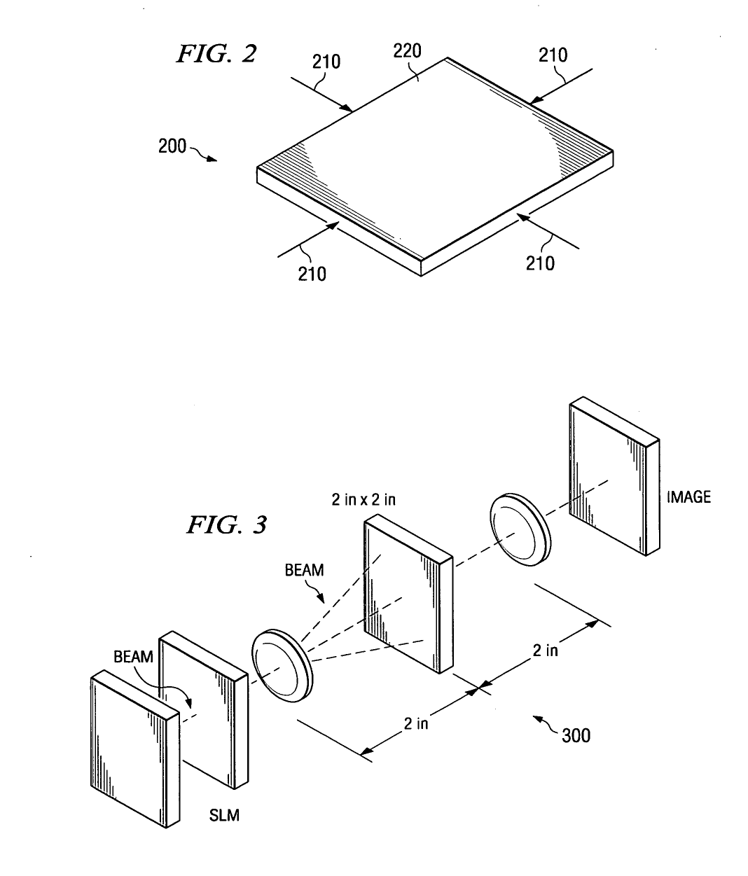

By utilizing wavelength multiplexing, with fast tunable lasers, and guiding optics to route the object and reference beams, to the fixed medium, the size of a holographic storage system, based on current embodiments of the invention, is greatly reduced. FIG. 2 shows a concept light 210 entering a medium 220 from the edges of the medium, which has the potential for volume savings greater than 8× over other conventional holographic addressing approaches and permits very thin packages that can use conventional surface mount packing to be placed on circuit cards, like other electronic chips. The space required by angle multiplexing is shown in FIG. 3 as a contrast to embodiments of the current invention.

The present disclosure contemplates a system having number of uses as a mass storage system, which would difficult or if not impossible with conventional addressing schemes or rotating medium. The system disclosed has an access time, due to using fixed medium and no moving parts, that be extremely fast, on the order of 100 us for inexpensive components and can be 1 us or less for specific embodiments. Hence the benefits of certain embodiments of the invention may be 1,000 to 10,000 times quicker for random accesses than disk drives, semiconductor flash memory and other holographic storage drives using rotational medium.

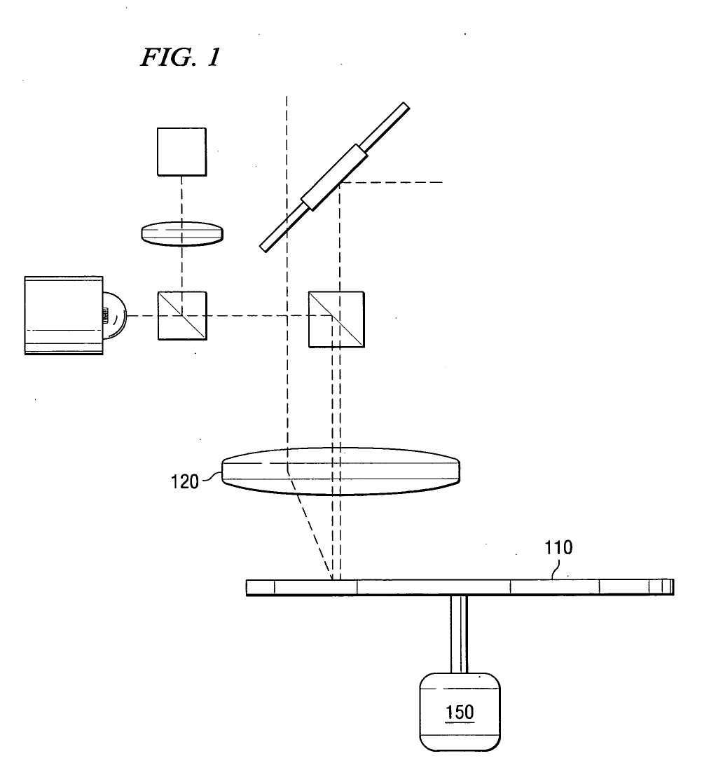

FIG. 1 illustrates a conventional holographic drive with a rotating medium 110. Some major disadvantages is the access latency due to requiring rotation of the medium 110 to the desired physical location and then radial positioning an optical head to the correct track for the write or read when randomly addressing the data. Also the ability to scale size down for very small consumer devices is limited due to the physical overhead of the associated drive motor 150 and mechanical components. Scaling to larger capacities by using a larger diameter medium is also disadvantaged in that with a larger diameter medium the rotational latency will increase further limiting the access rates, which is the same problem facing magnetic disk drives. The slow access times limit the usefulness in high data rate applications such as transaction-based uses, fast data mining, web-hosting where literally thousands of different requests occur simultaneously over broadband and fiber-networks running at Gbps to tens of Gbps.

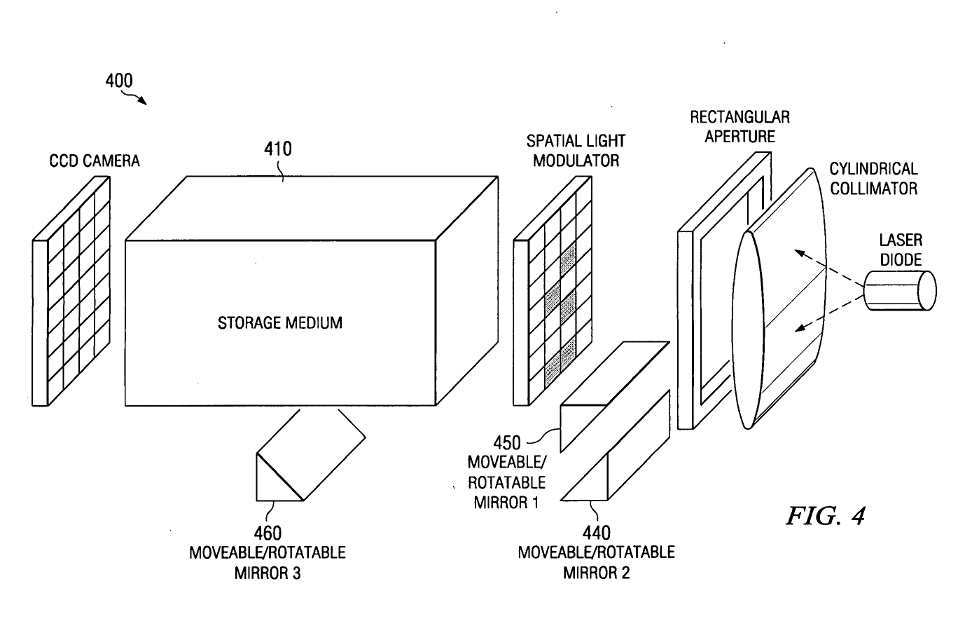

FIG. 4, illustrates a compact holographic device which avoids rotating medium performance issues. It uses a fixed media 410 but moves the optical head, defined here as the opto-electronics and optics necessary to encode electrical data onto the light beams and decode data upon readout. It laterally moves and rotates a mirror 460 along an axis parallel the image beam path to generate intersecting beams in desired medium location for addressing holograms. A servo (not shown) also moves the laser position and their beams on a face of the medium 410. The optics size is about the size of the entry face of the medium, therefore increasing a face size for larger capacity implies larger SLMs, and image sensors along with optics, which is a major cost factor. The translation forces required to move and rotate the mirrors will limit access rates. Scaling to terabyte capacities in single devices appear difficult. Terabyte capacities may require replication of many devices, hence increasing complexity and cost. The pixel formats (number of pixels and their pitch) of the SLM and imager are limitations of the size of the respective medium faces that can be accessed and hence limit the capacity for a single device. For example an SLM with 3-micron pitch and 1024×1024 format would have approximate dimensions of 3 mm (1024 times 3 microns), which would constrain the size of the medium and therefore the capacity. If the size of the SLM increases to match the media face, the package dimension become thicker, and the cost of the SLM and Imager increase. There is a tight coupling of the SLM/Imager and face size.

Significant scale up in capacity requires replication of devices or translation of the mirrors over longer and longer medium dimensions, which cause the same negative performance issues as a rotating medium, both using physical movement of optical head components.

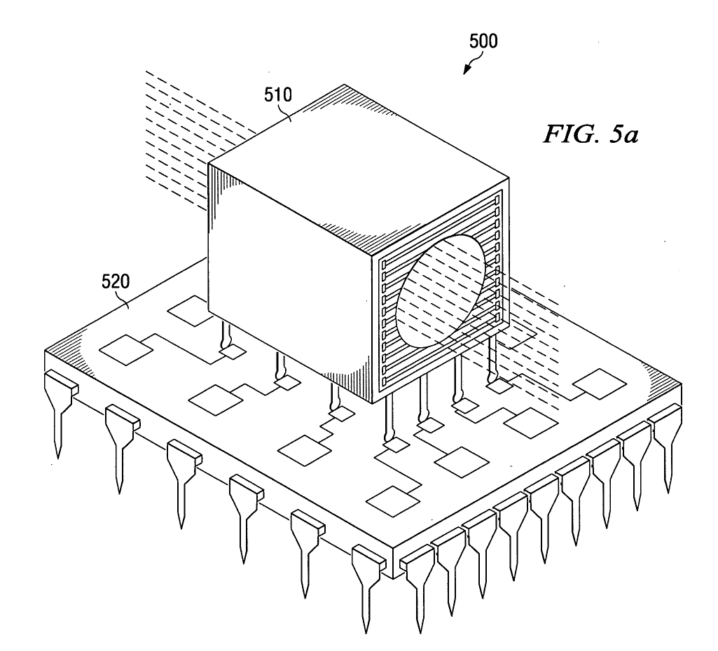

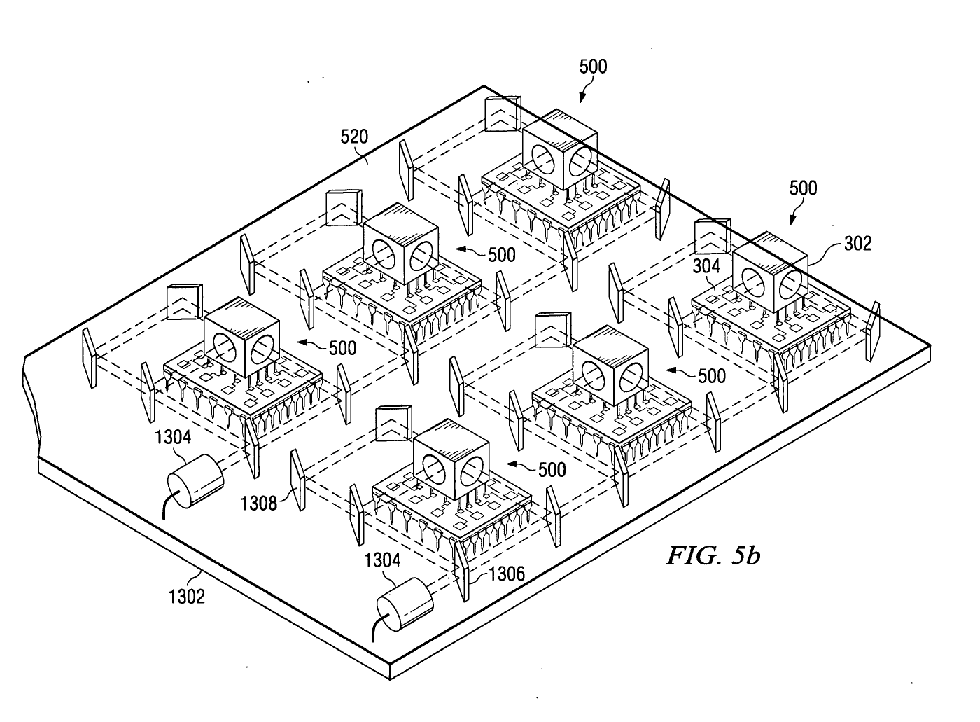

FIGS. 5a and 5b illustrate another chip-based embodiment that proposes to implement various multiplexing schemes with a fixed medium. In general the size of the medium, in a cube-like form is matched on its faces with the optoelectronic components. Therefore the pixel pitch size and number will constrain the size of the medium and therefore capacity for a single device. Their approach to increasing capacity beyond a single building block is replication of the whole device on a circuit card 520. The estimate for a card of 100 such devices at 2 Gbits per device is therefore 200 Gbits (25 GB). A complexity of 100 devices and 100 optical heads may be cost prohibitive for commercialization. A page size of 1 Mbit implies an SLM of about 1024×1024. Assuming a 5 um pixel pitch, a 5 mm footprint would be result (5 um×1024) for a single medium face alone. A hundred devices providing 25 GB would not be very competitive with today's flash memory chips or small 1 or 2-inch disk drives. Due to the cubic physical form of the medium, very slim, thin packages for consumer devices may be difficult to achieve at a reasonable capacity and at thickness constraint of a few millimeters.

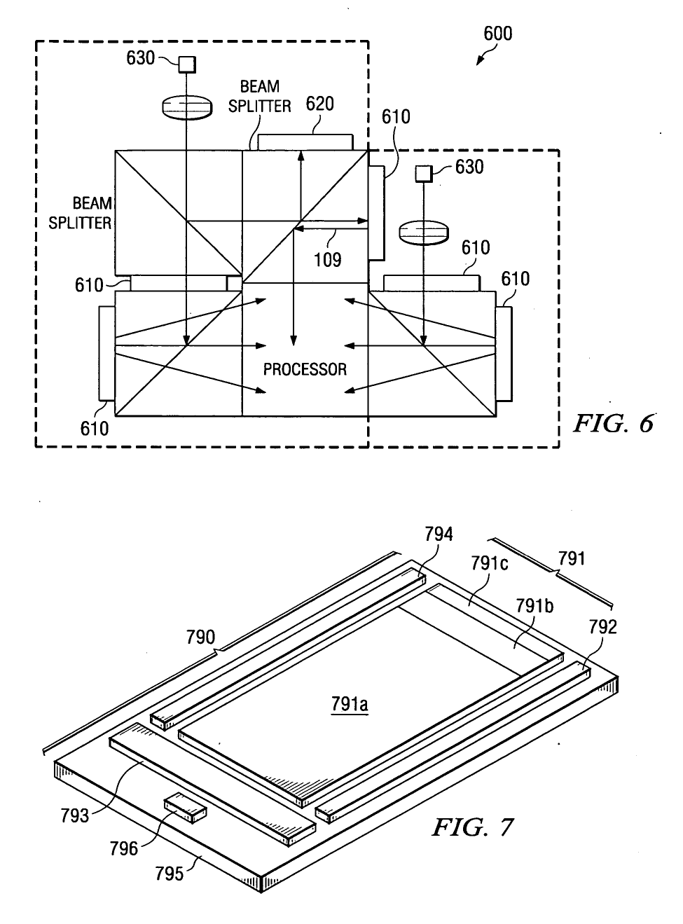

FIG. 6 illustrates another compact holographic device 600 with a fixed medium 612. Its disadvantages are the same as the devices in FIGS. 4, and 5, but it uses even more active components for each medium cube, 5 active SLMs or BSSLMs 610, photodetectors 620 and a laser 630. Scaling may therefore be difficult also when required capacities exceed a single medium. The approach also has the similar constraint of the above fixed medium approaches of matching the SLM or detector size to the medium cube face size. This makes achieving very high capacity and at the same time achieving a thin form factor of only a few millimeters very difficult.

Magnetic disk drives have the same scaling issues and a rotating medium, holographic drive as previously discussed. Total latencies due the magnetic platter rotating and read/write head track seek time, range in the 15-35 milliseconds depending on the platter diameter and rotational speed. This is a severe constraint on random access of data for high-speed applications needing thousands to tens of thousands of accesses per second and a major factor for slow application switching in personal computers.

Flash drives employing silicon have a latency that is generally better than disk drives, however the capacities do not scale to the 100s of GB, as do magnetic disk drives or holographic drives. The flash cards or drives do permit a small, thin form factor of a few millimeters, are slow for random accesses, fast for sequential addresses once the addressing mechanism is in a flash defined page area. Flash had endurance issues in that they wear out with repeated write/read/erase cycles. Capacities are typically in the few gigabytes. Their future scaling in capacity is dependent upon the semiconductor feature size continued reduction with many industry predictions of a slowing of the future capacity growth. Scaling is limited to the size of silicon chips, which is on the order of 5-15 mm.

USB memory sticks are typically built today using a semiconductor memory (flash memory vendors for example are Intel, Micron and Samsung) or micro magnetic disk drives. Samsung has a 2 GB flash device, part number (K9WAG08U1M) and Toshiba has a micro-disk drives (0.85 inch magnetic platter diameter, 4 GB capacity), a 1.8″ drive with 80 GB (Toshiba MK8007GAH) with a 15 ms average latency (25 ms maximum). The flash memory chips have about 1-2 GB of capacity and enjoy widespread use, however it has limitations, which are limited random access speeds and slow write speeds (about 8 MB/sec). When data is on the flash device “page” then transfers occur at rates of 20 MB/s for NAND type flash. In addition the devices have endurance issues are advertised for only limited write/read/erase cycles on the order of 100,000 to a million cycles and then they degrade with sections becoming faulty. The limited endurance in cycles limits the usefulness in some high-speed applications.

The disk drive based versions have significantly larger capacity about 80 GB however they use mechanical parts and are very slow. The data rates are on the order of 20-40 MB/s with a total latency and seek delay or 22-33 ms, which implies they can only be addressed randomly about 50 times per second.

The disk drive based versions have significantly larger capacity˜up to 80 GB however they use mechanical parts and are very slow. The data rates are on the order of 20-40 MB/s with a total latency and seek delay or 22-33 ms, which implies they can only be addressed randomly about 50 times per second.

Some possible applications of the various embodiments of the invention are shown in the following examples and indicate the flexibility in the invention due to the ability to make storage devices very small (on the order of a square inch surface area by only a few millimeters thick) or scale to large sizes and provide electrical interfaces to industry standards. The ease with which the invention's size and interface may be changed permits specific embodiments of the invention to be used in the following example applications, however it is not limited to only these applications. Some of the applications include, but are not limited to, storage for Memory Sticks, Accelerated Disk Drivea, PC Motherboard Storage, RAID Rack Storage, Digital Cameras & Camcorders, Personal Computers, Servers and Supercomputers, Laptop Computers, Personal Digital Assistants, Music Players (MP3), TV Set top boxes, Video Games, Cell phones, TV VCRs, and LCD TVs

The above electronic items are referred to as Host Equipment or Host Devices hereafter as well as other electronic devices that utilize or have need for a mass storage system but are not listed above.

These above applications, products and equipment may connect or interface to embodiments of the invention device by electronic methods with industry standard interfaces and protocols or make develop non-standard interfaces or protocols. Mounting or physically securing the instant embodiment of the invention inside the Host System can be accomplished by standard conventional methods used for mounting other mass storage devices, such as done with disk drives, or other larger electronic components and devices and is known by those practiced in the art. Small sized embodiments of the invention can be mounted on a PC cards or motherboard similar to mounting integrated circuits. In general, embodiments of the invention can be physically mounted inside the Host System enclosure or on the exterior enclosure of the Host System. In alternative embodiments the invention may be actually integrated or embedded into the case or enclosing structure for the above Host System as a result of the thin sizes for such invention embodiments. Other embodiments for the invention may be a standalone device interfacing to other electronic devices by industry standard communication interfaces.

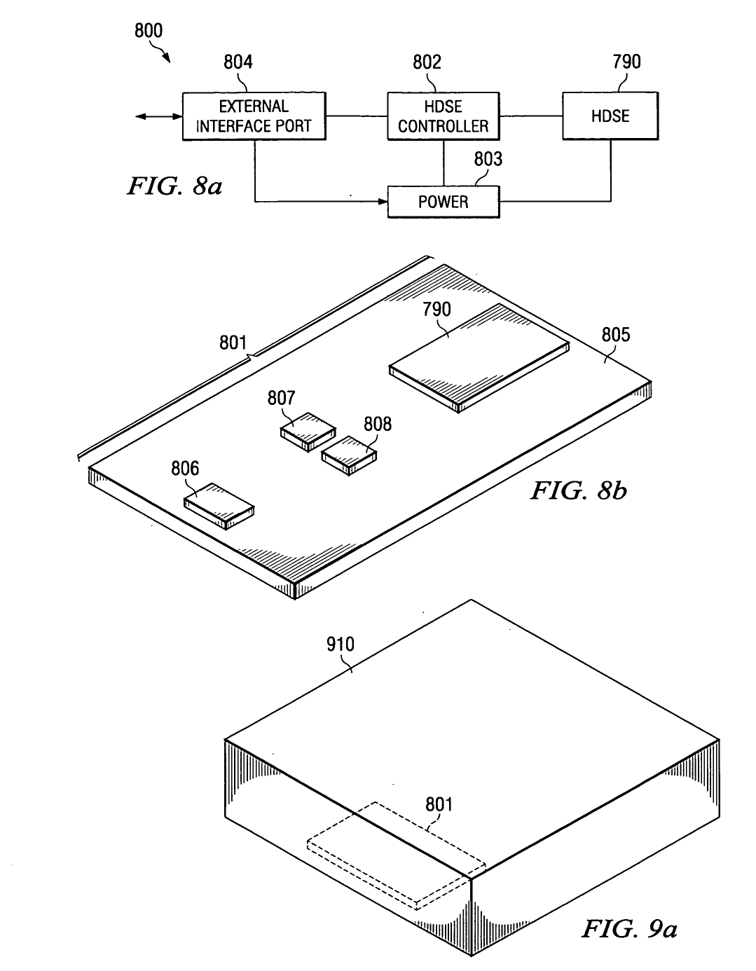

One embodiment of a holographic data storage system is illustrated in FIGS. 8a and 8b. A key element is block 790, which is referred to hereafter as a holographic data storage engine (HDSE), which is illustrated in FIG. 7. As shown in FIG. 7 the HDSE block 790, consists of a medium 791, optical beam routing 792 (referred to hereafter as optical rails) to route the signal beam and reference beam, pump beam and erase beam to a medium 791 in order to write holograms, read holograms and erase holograms and pump the medium. An optoelectronic section 793 contains optoelectronic components such as the SLMs, imager, light sources, optics and other electronics to encode the signal and reference beams to write data to the medium 791 and erase data on the medium 791, and receive the reconstructed hologram resulting from a read and convert the hologram to digital data. Block 793 also may provide the erase beam and pump beam. Block 793 may control the routing of the beam paths in the Optical Rails 792 and 794 to the addressed medium location. Block 793 will be referred to hereafter as the Optical Head (793). Block 791, may consist of more than one medium type represented by 791a which may be a protein-based medium of type in and 791b which may be a photopolymer medium type, and 791c that may be a photorefractive crystal type of medium. Some embodiment may have different amounts of each medium, each separately addressable. The blocks 791, 792, 793, 794 may be mounted on a substrate (795) to secure the components. A connector 796 may be used to interface with other electronic components.

Referring again to FIG. 8, the data read from an addressed hologram can be sent to an external port 804 via block 802 for external use. The Optical Head (793) may accept read, write, pump and erase addresses from port 804 and then may access the medium with the addresses for data storage, retrieval and erasing. The Optical Head 793 will accept data to be stored and output data retrieved by external Port 804. Block 802 may provide the command interpretation, and general control, encoding, decoding of SLM and imager data from the medium to provide substantially and error free mass storage system using holographic storage techniques as known in the art and disclosed herein. Power may be supplied externally via block 804 and may be conditioned and distributed by block 803 to block 802, block 804, and block 790. The design and implementation of block 802 and 804 is known to those skilled in the art. Interfacing the data to external devices is also known to those skilled in the art of computer and network interfaces.

The present disclosure contemplates a rewriteable, nonvolatile, erasable holographic storage medium, and whose exposure, read, pump and erase controls may be provided by block 802 and 790 in FIG. 8a. Such as system is disclosed in U.S. Provisional Application No. 60/618,921, filed Oct. 14, 2004, titled “USES OF WAVE GUIDED MINIATURE HOLOGRAPHIC SYSTEM,” U.S. Provisional Application No. 60/618,917, filed Oct. 14, 2004, titled “MINIATURE GUIDED WAVELENGTH MULTIPLEXED HOLOGRAPHIC STORAGE SYSTEM,” and U.S. Provisional Application No. 60/618,916, filed Oct. 14, 2004, titled “BRANCH PHOTOCYCLE TECHNIQUE FOR HOLOGRAPHIC RECORDING IN BACTERIORHODOPSIN,” hereby incorporated by reference. By sharing the using two media types for 790 (791a and 791b), where 791a is of the type in the aforementioned applications, and 791b is of a photopolymer type which may be a write once, read many medium (WORM), then the current embodiment of the invention is a hybrid holographic data storage device that may contain addresses that are WORM and other addresses that may be rewriteable.

The Holographic Data Storage Device (HDSD) 800 may have various physical embodiments, as shown in FIG. 8b. A mounting base or printed circuit card (referred to as card) 805 may provide the structure to mount the various components. The HDSD 790 interfaces to block 807 which may be integrated circuits implementing the HDSE controller 802 from FIG. 8a. Other chips may be interface chip(s) 808 and a circuit card interface 806 for data to enter and exit the card 805 and hence the embodiment 801. The most common device for block 806 is a connector, which plugs into another mating connector and therefore may use electrical signals on a physical cable or light signals in a fiber or waveguide. However, the external interface 806 in other embodiments may use wireless, infrared, RF transmissions or light, using available industry components known to those practiced in the art.

Circuit card 805 provides a secure mounting platform for the components and devices. The types of components use and card size 805 will vary with the specific embodiment capacity and data rates required. For small physical embodiments of the invention, capacities may range in the 50-100 GB and terabytes for larger embodiments. Sizes may range from a postage stamp size and a thickness of a millimeter to a several 100 millimeters on a face with a few millimeters thickness. Other embodiments may increase thickness to tens of millimeters to fully utilize the Host packaging.

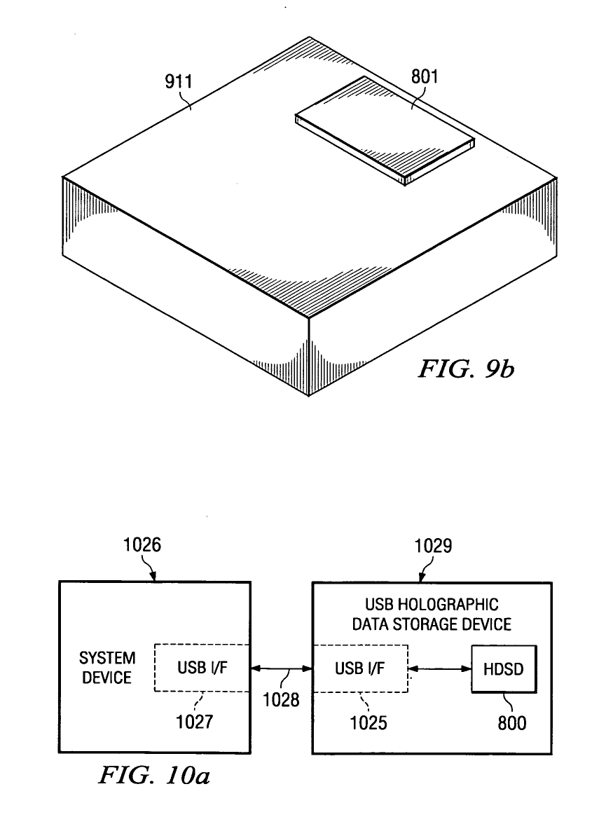

The system herein disclosed may be used in various electronic equipment and devices. The system may be mounted internally in other equipment as shown in FIG. 9a or externally, FIG. 9b. Due to no moving parts in the current embodiment, mounting in many devices is facilitated and there are minimal concerns for vibration, which are issues with rotational medium approaches for both magnetic disk or holographic storage systems.

A feature of some embodiments of the invention is the ability to use medium at various sizes for many different applications or products.

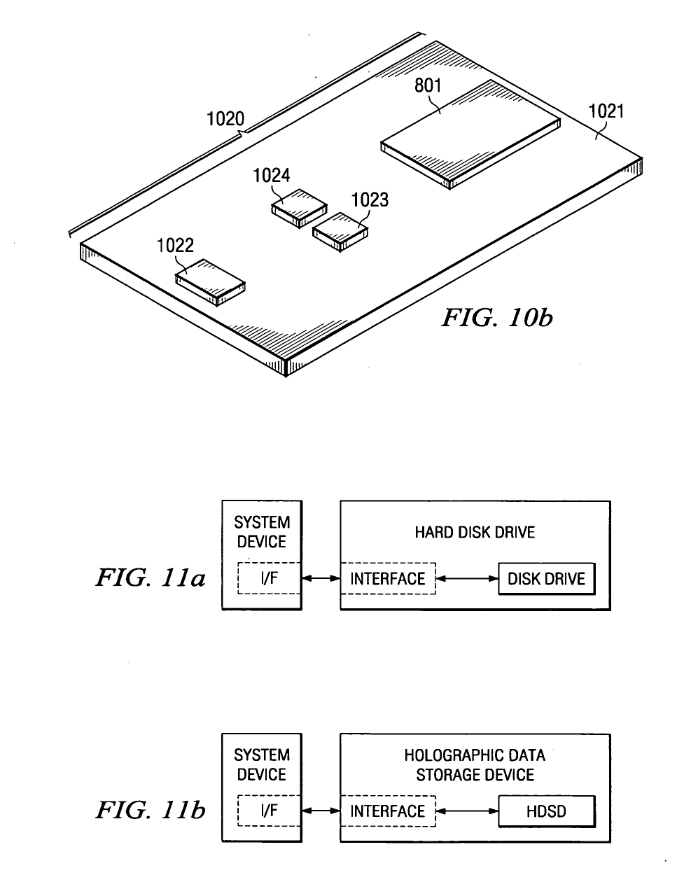

An example application is a portable storage device built around a[[n]] USB (Universal Serial Bus, an industry standard) interface such as an USB Memory Stick. A block diagram of such a device is shown in FIG. 10a.

The USB holographic data storage embodiment may provide a capacity of 75 GB, with access times of 0.5-1 ms, which may support data rates of over 1 Gbps, which surpasses the USB bus standard of 480 Mbps.

In FIGS. 10a and 10b, the USB Interface (I/F) block 125 may provide the electrical interface according to USB standards to interface HDSD 800 to the System Device 1026 via block 1025, block 1028, and block 1027, where in accordance with the USB published standard the block 1020 is the storage device and the Host is the particular System Device 1026. Protocols may be handled in hardware and software in block 1025 and the System Device block 1027.

The system device 1026 may be a host computer, laptop, PDA or some other electronic system that can communicate by a USB interface with a physical cable 1028 and therefore could access the mass storage memory embodiment 1029.

A specific physical embodiment is shown in FIG. 10b. The holographic storage USB device 1020 is shown on a small circuit card that may be used to mount various electronic components and integrated circuits. A USB connector 1022 is shown which connects to the particular System Device 1026 (FIG. 10a) that will employ a USB memory device. The protocol standard for USB can be handled by one of many commercially available USB microcontroller integrated circuits (such as the vendor Cypress Semiconductor part number CY7C68013A-56) Block 1023. The USB chip 1023 may provide the required protocol by the System Device 1026 (Host as named in the USB standard) and may interface to an FPGA 1024 (Field Programmable Gate Array, which is available from many vendors, such as Altera, Xlinix, Atmel). The FPGA 1024 whose design is known to those skilled in the art of electrical engineering and computer science, may provide the additional protocol interfaces required for USB standard and may perform data transfers and reformatting between the USB Controller 1023 and block 800. The FPGA 1024 in some embodiments may be the controller for the operations and processing for the block 800.

The capacity of the USB invention embodiment 1020 incorporating holographic storage depends upon the actual package size but may be 75 GB for a package 5 mm×65 mm×10 mm (which is ½ the physical volume of a Lexar Jump Drive commercial product, having only 1 GB capacity). In addition assuming a SLM and Imager of 5 Mpixels at a 1 ms write/read time the data rate may be about 5 Gbps, much higher than the USB 2 standard for wire speed of 480 Mbps. An embodiment using 5 Mpixels at 30 reads per second would provide about 500 Mbps data rate. The capacity naturally would progress as improved media became available and shorter wavelengths lasers. Higher speeds would also be possible as the semiconductor technology progressed and speeds increased.

Another application of the system presently disclosed is a mass storage accelerator for hard disk drive replacement. Embodiments of the invention may permit speed up or acceleration of applications running on computers of all types, desktops, laptops, servers and supercomputers. In general any application using disk drives as the mass storage device may show significant speed up in application execution, application switching and boot-up of 100×-1000×.

This embodiment of the holographic data storage system may provide 100 us random access rates with 10 Gbps data rate for a 1,000× speed up factor over disk drives. Another key benefit example is to consider a PC with a 100 GB disk for mass storage and 1 GB of RAM. Swapping data from disk to RAM for immediate CPU use and back to disk as the application executes creates many delays for the user. The invention embodiment may transfer a 1 GB file to the CPU on demand in about ⅙ of a second, supported by an imager readout rate of 48 Gbps achievable with 16 ports at 3 Gbps data rate each, easily done with current semiconductor serial interface technology (for example Altera FPGAs offers serial interfaces up to 6.375 Gbps in their Stratix II GX series, Altera, 101 Innovation Drive, San Jose, Calif. 95134). Specific embodiments, can fit into the standard 3.5-inch, 2.5-inch, 1.8-inch, 1-inch or smaller form factor. The changes in each embodiment being the number of media rods (or size of the media slab) and corresponding lengthening or shortening of the Rails (792, FIG. 7) to route the light beams to the medium (791, FIG. 7). A block diagram of the embodiment is illustrated in FIG. 11b, as compared to a standard disk drive, is shown in FIG. 11a.

A physical embodiment (block 1130) is illustrated in FIG. 11c. The dimensions of the card 1134 may fit in a magnetic disk drive case form factor which for 3.5 in disks are: 146 mm×101 mm×26 mm (Seagate's Barracuda drive, 7200.8 SATA NCQ—ST3400832AS, Seagate Technology, 920 Disc Drive, Scotts Valley, Calif. 95066). The capacity of the HDSD for the stated case size may be over 5,000 GB with data rates from the medium over 20 Gbps with random access times under 300 us.

A circuit card 1134 provides a secure mounting base for the components of the embodiment. Block 801 is the HDSD, block 1133, an FPGA, may provide control of the HDSD 801 and block 1131, may be an FPGA providing the specific interface protocols for the industry standard disk interface which may be Serial ATA. Block 1132 providing the physical connector for the interface standard implemented.

The dimensions of the card 1134, with a reduced in the media size and hence capacity can be sized to fit in the 2.5 in drive standard case (Seagate Savio drive ST973401LC/FC, for example which is 112 mm×70 mm×26 mm). The capacity would be over 2,200 GB with data rates over 20 Gbps and random access times of 300 us for the embodiment of 11c.

Likewise the card 1134 from embodiment 11c can be reduced to fit in a 1.8″ drive form factor (78 mm×54 mm×8 mm) by reduction of the block 801 HDSD size by reducing the media volume of 790 by reducing 791 which substantially reduces the size of the PC card 1134. The resulting capacity may be 500 GB, with data rates of 20 Gbps and random access times of 250 us.

Likewise the card from embodiment 15c can be reduced to fit in a 1.0″ drive form factor (42 mm×36 mm×5 mm) by reduction of the block [[101]]801 size by reducing the media volume of 790 by reducing 791 which substantially reduces the size of the PC card 1134. The resulting capacity of the embodiment may be 100 GB, with data rates of 10 Gbps and random access times of 250 us.

The drive interface sub blocks in 11b and block 1132, 1131 (FIG. 11c) will provide the electrical interface according to specific standards to Interface to the System Device. Protocols will be handled in hardware and software in the Holographic Data Storage Device sub block and the System Device sub block, which is known by those skilled in the art. Examples of some of the disk drive industry standard interfaces are ATA (serial and parallel), USB, Fiberchannel, SCSI and iSCSI, IEEE 1394 Firewire, and IDE.

The above interfaces may be handled with integrated circuits especially built for the above interfaces, or be implemented is FPGAs (Altera) or on separate circuit card that may be mounted on a card shown in FIGS. 11b and 11c. Development of an interface to provide the proper protocols (whether in hardware or software or combinations of hardware and software) is understood by those skilled in the art.

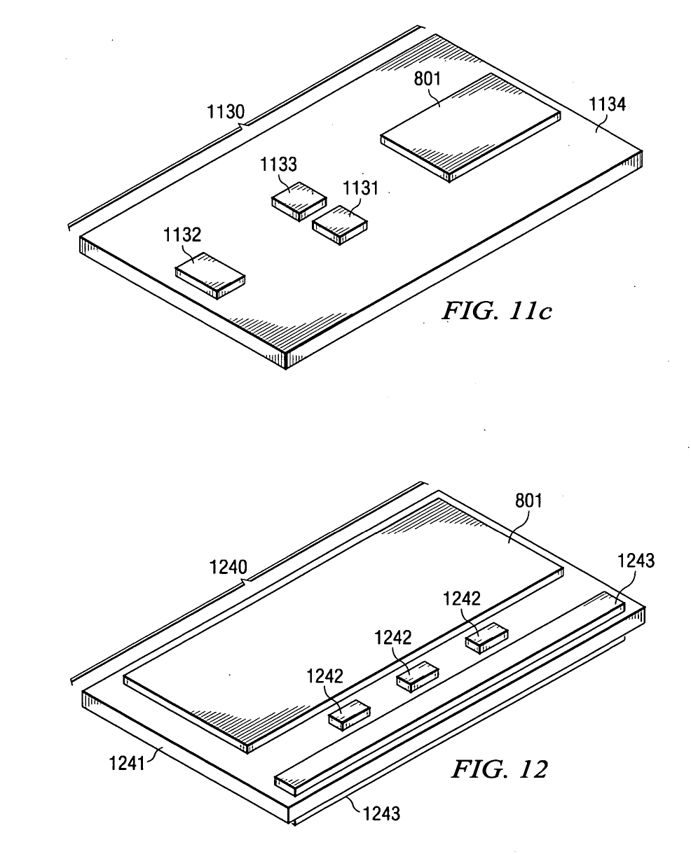

Another application embodiment for the system of the present disclosure is an accelerated mass storage for fast storage on a PC Motherboard. This embodiment may be used provide a very fast context swap while providing extremely high storage capacities. Another use is enabling a very fast system start up which can be achieved by storing the start up data in the present embodiment of the invention. The high capacity and fast speed of the HDSD provide the fast startup. The HDSD, because of its small size may be put into a form factor that will fit in into standard DRAM (dynamic random access memory) sockets which are illustrated in FIG. 12. Block 801 is the HDSD on both sides of block 1241 which is the substrate or circuit card. Block 801 may interface to FGPAs 1242 which may provide the specific protocols for the DRAM socket interfaces via connectors 1243 on both sides of the card 1244. Software drivers changes may be required in the host to fully utilize the benefits of the current embodiment.

The HDSD in the DRAM socket embodiment may have a 100 GB capacity in a physical size of 130 mm×30 mm×5 mm and makes use of a dual layer medium which may provide medium on two sides of a substrate. The embodiment may provide 20 Gbps data rates and access times of 100 us and eventually 1 us. Current DRAM sizes are 133 mm×30 mm×6.81 mm for a capacity of 4-8 GB. A functional operation using other embodiments is different than using DRAM. DRAM support the cycle-to-cycle operation, typically under a 100 ns, with the CPU in executing instructions. The initial embodiments may not support the sub 100 ns cycles times of DRAM. However by putting several 100 GB of an embodiment of the invention in DRAM sockets, the computer software applications opening, switching, saving and closing would be extremely fast in the sub second times whereas currently such activities often take 10s of seconds to sometimes minutes.

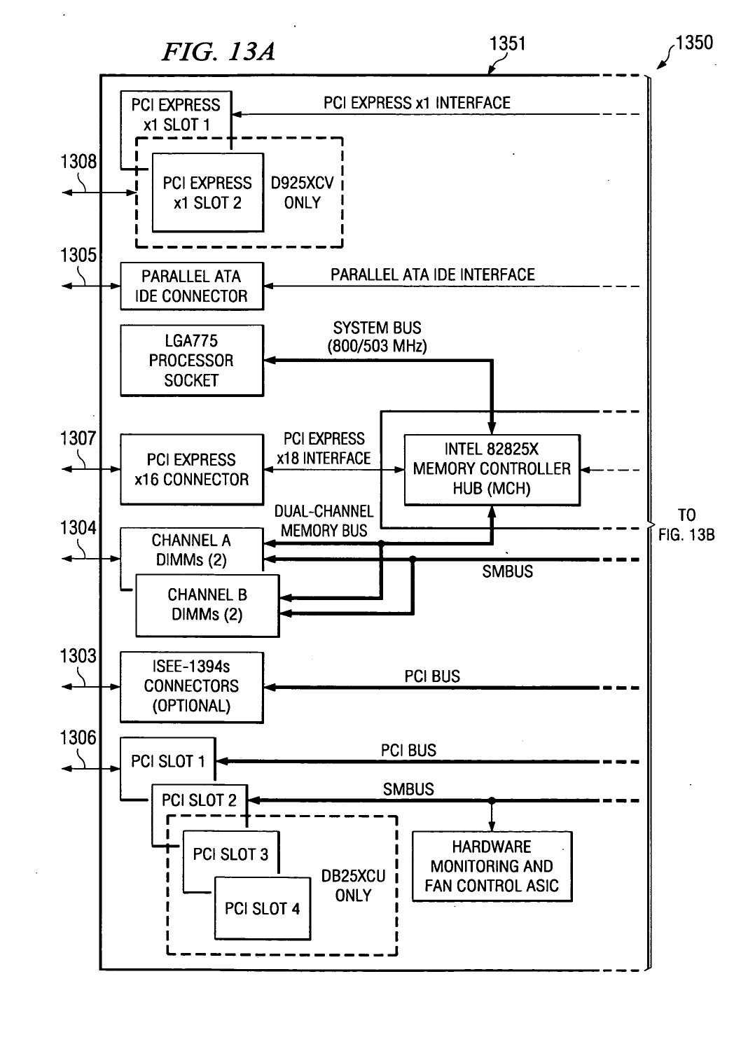

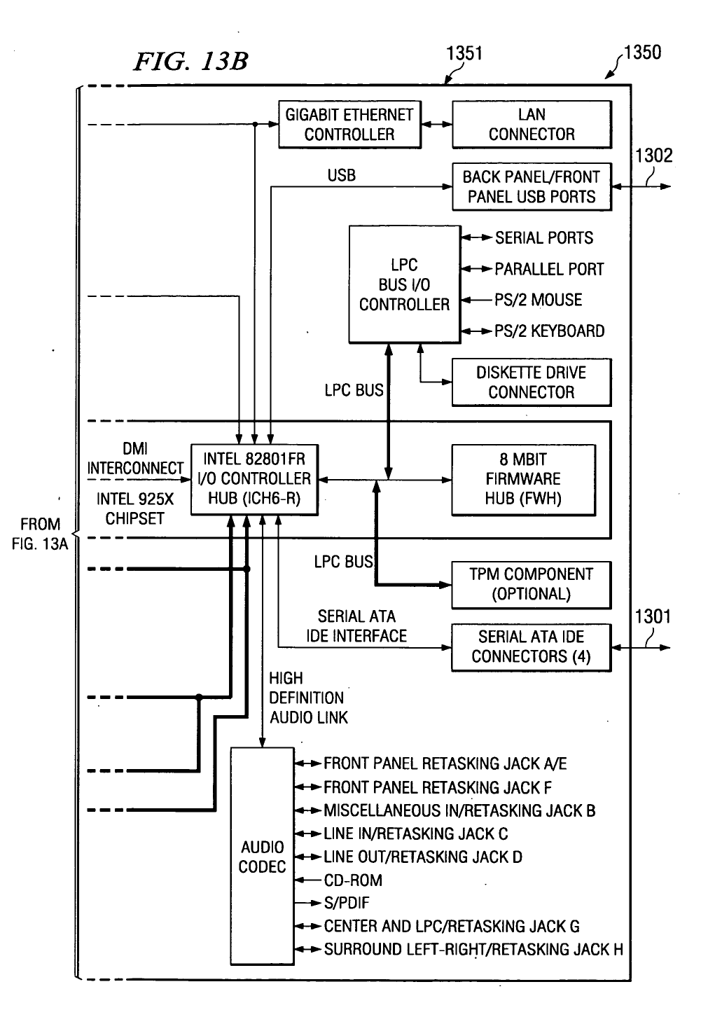

Other embodiments, due to the small size of the embodiment storage devices, may be directly mounted or interfaced on a motherboard in alternatives other than the DRAM sockets mentioned above. The other embodiments are illustrated in FIGS. 13A and 13B with a diagram of a PC motherboard 1351. Examples shown where embodiments of the invention may interface are block 1 for Serial ATA, block 4 DRAM as previously discussed; block 6 PCI slots or block 8 (PCI express slots). Each these embodiments of the invention interface to the PC motherboard 1351 differently in substantially in accordance with various industry interface standards to provide a holographic mass storage device, which may provide application acceleration. Examples of possible interfaces for the specific Intel motherboard 1351 are shown blocks 1301, 1302, 1303, 1304, 1305, 1306, 1307, and 1308, but would not be limited to these. Each interface will have varying speed differences in accordance with the Industry Standard utilized. Some of these standards are PCI, PCI express, Serial ATA, Fiber channel and Parallel ATA IDE. The method to interface various embodiments of the invention is known to those skilled in the art.

As has been shown in FIG. 12, embodiment 1240, some embodiments can be placed in sockets on a motherboard 1351. FIG. 13, blocks 1301, 1302, 1303, 1304, 1305, 1306, 1307, and 1308 indicate other places where specific embodiments of the invention can be interfaced.

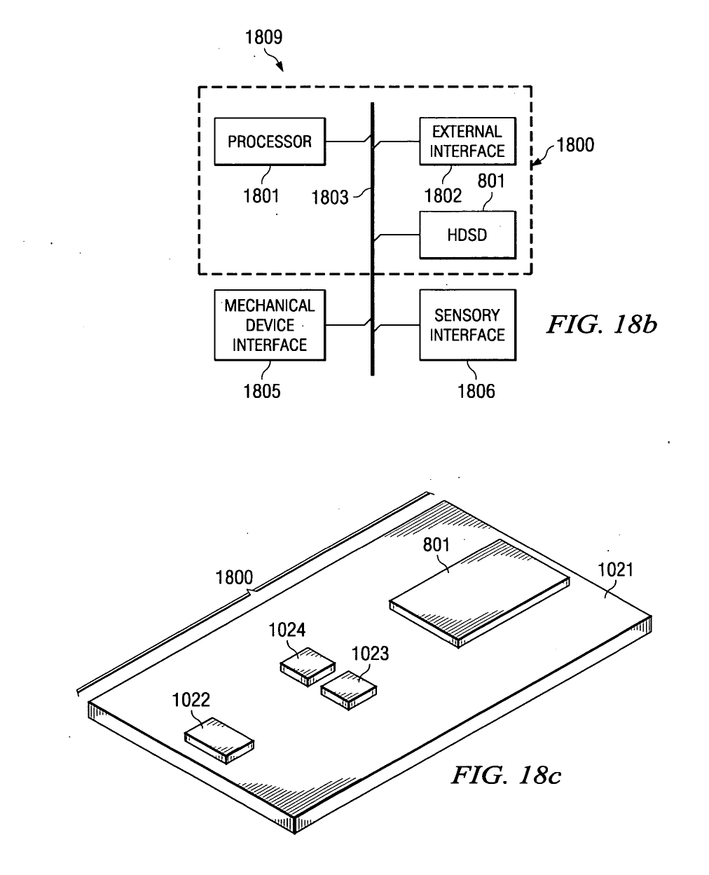

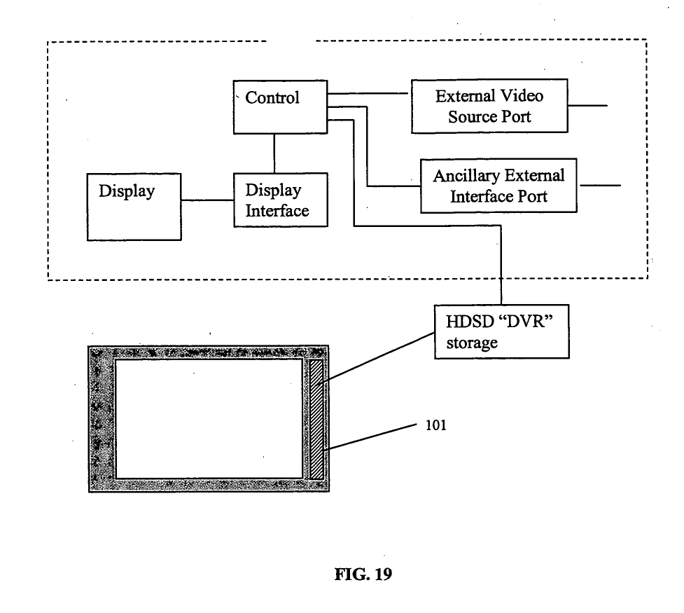

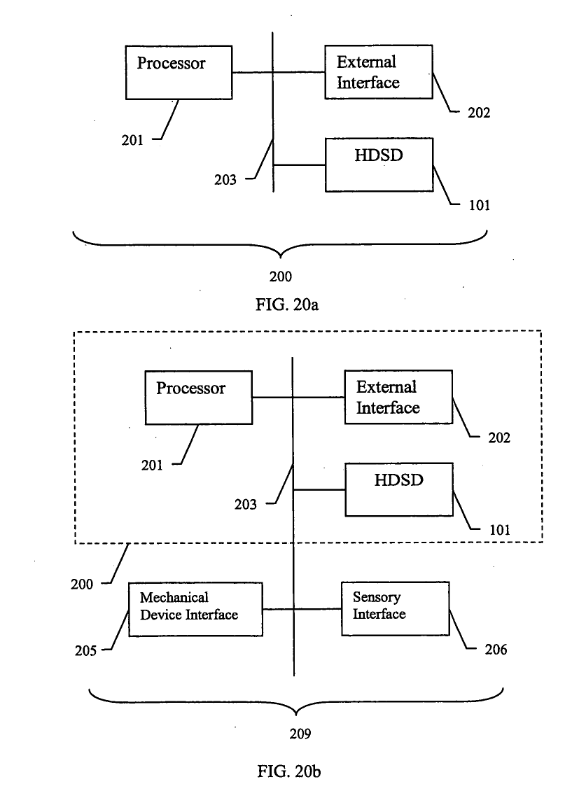

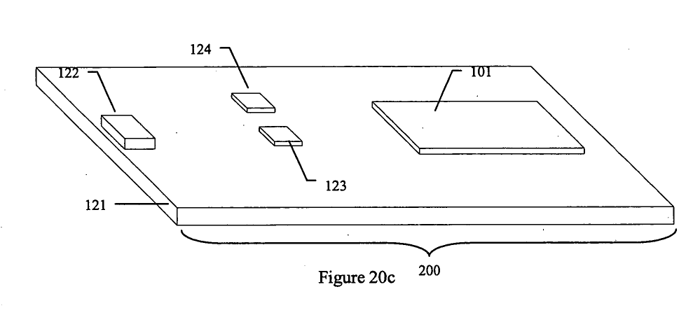

In general, embodiments of the present disclosure may interface to any CPU or microcontroller based electronic device that utilizes or mass storage (magnetic disk, or flash or CD or DVD in any substantial mass storage capacity) or has the need for mass storage as illustrated in FIG. 18a.

A portable electronic device block 1800 may consist of a processor 1801 and an external interface 1802 and mass storage 801 (an embodiment of the invention in FIG. 8). The processor 1801, External Interface 1802 and Mass Storage 801 communicate internally by 1803 to exchange data and commands. Block 1803 may provide communications by using an electrical bus, optical bus, a wireless bus and other methods known to those skilled in the art. The processor 1801 executes programs, interprets internal and externally provided commands and may provide overall control for block 1801, 1802, and 1803. The processor types and method of programming, design and use are known to those skilled in the art. The external interface 1802 may provide communication with external electronic devices by physical means using a connectors and wires to carry electric current or optical conduit to carry light, or may communicate without any physical connection by electromagnetic waves essentially known as radio frequency waves or essentially using light waves and emissions in the electromagnetic spectrum including sound, infrared and ultra-wideband techniques. Some methods for the external interface based on industry standards are USB, Firewire, Ethernet, Wireless Local Area Networks, RS-232 serial, infrared wireless, and Bluetooth. The components and approach to provide the external interface 202 are known to those skilled in the art.

Embodiment 1809 in FIG. 18b may use the embodiment of FIG. 18a and may add a Sensory Interface 1806 and may add a Mechanical Device Interface 1805 to provide additional uses. The Sensory Interface 806 may provide input and output using sound, light or physical contact (touch). Interface 1806 may provide a visual display of data essentially by converting data to light whose spectrum is essentially in the visible regions of the electromagnetic spectrum to cause images to be seen by humans, a computer display being an example, a heads-up display is another example. The Sensory Interface 206 may also input light from an image sensor converted to an electrical signal, an example being a digital camera, video or still frame images. The Sensory Interface 206 may also provide tactile input and output with computer keyboards and computer mice or computer touch pads being examples. The Sensory Interface 1806 may also provide input and output by converting data to sound waves and converting sound waves to data and where said sound waves wavelength is essentially audible for humans with example devices being microphones and speaker, headphones, and earplugs.

The mechanical device interface 1805 may provide input and output in the form of physical movement or motion and may translate data and or commands to generate physical motion and may translate physical movement or motion into data and or commands. Examples are a joystick, motion transducers, motors, mechanical x, y, z position translators. The mechanical Interface devices may create inputs for block 1800 or receive commands and cause motion. The mechanical device interface 1805 and Sensory interface 1806 may communicate by 1803 exchanging data and commands.

Other embodiments of FIG. 18a or 18b, may include block 801 consisting of removable medium 791.

The HDSD due to its data rates, access rate and high capacity, which is substantially larger than magnetic disk, flash and DVD can be interfaced to accelerate the program execution and provide higher capacity mass storage. The HDSD due to its ability to scale from very small sizes and to large sizes can physically be placed in or on or attached to any such CPU or microcontroller based electronic device. In some embodiments, the electronic host device furthermore may not have a CPU or microcontroller, but utilize the invention's CPU or microcontroller. Likewise in some embodiments, the invention of FIG. 9 Block 90 may be utilized with the Host Device providing the control of Block 90.

The interfaces in 1809 permit the various embodiments of the present disclosure to be used for handheld devices that: essentially record and playback audio, examples are MP3 players, Apple iPods; essentially record and playback video content, examples are video recorders; essentially record images and transfer the images to other storage devices or computers or printers to print said images, examples are digital cameras; essentially are used for communications, examples are cell phones; essentially store, organize, perform computation on information, examples are laptops, PDAs; essentially playback video with input and control from the users for games and entertainment, examples are video game consoles.

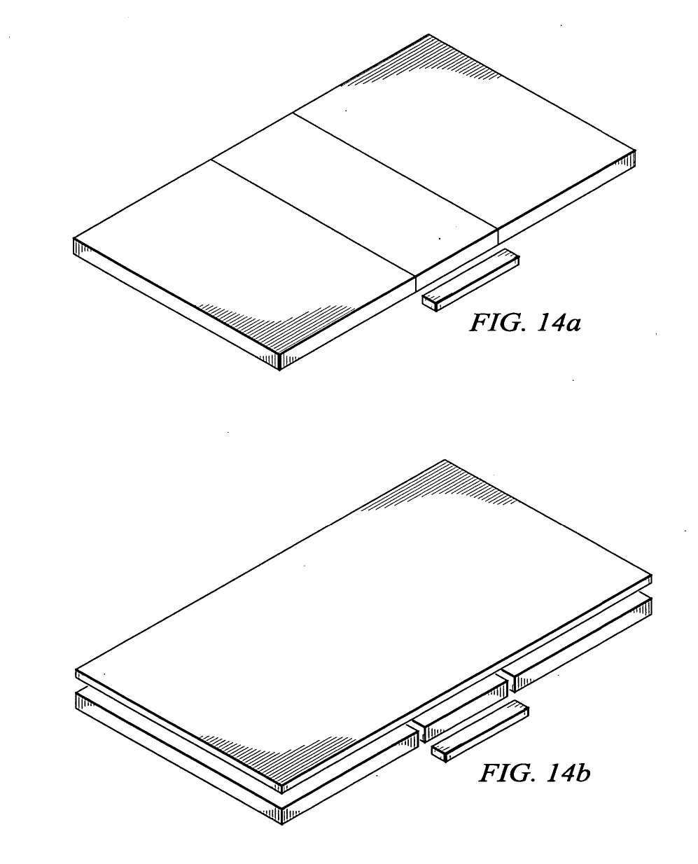

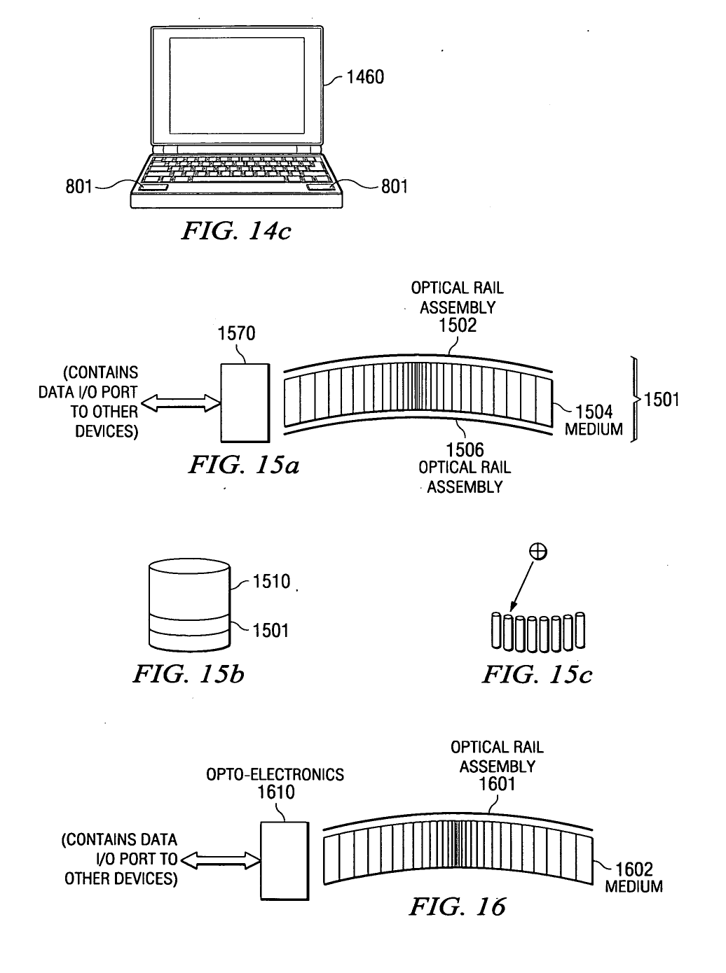

Another embodiment of the present disclosure embeds a memory system into the case of a Host device. The thin packaging of the system disclosed herein, which can be on the order of 1 or 2 millimeters thick for some embodiments and due to an embodiment using medium made from polymers or other materials that can be formed or shaped, it can be embedded as part of the case also providing structural benefit. The multifunctional use of the present embodiment (providing storage and structural benefit as part of the case) reduces the overall volume required for the laptop FIG. 14c shown in this example because the invention will not use substantial volume inside the Host laptop computer or device. The same general advantage will hold for PDAs, cell phones, cameras and other mobile electronic devices. FIGS. 14a and 14b illustrates this embodiment of incorporating or embedding the invention into the case or skin of a host system or device.

Some embodiments of the present disclosure (FIG. 7, block 790) may use polymer-based medium that will permit shaping the media to a curve or non-flat surface. The medium could be either slab-like or composed of rods. Dimensions would be determined based on desired capacity, optical components used and the amount of structure support was desired or available to maintain rigidity of the medium.

FIG. 15, illustrates a contoured embodiment of the present disclosure and FIG. 16 a conjugate embodiment.

FIG. 16, illustrates an optical rail assembly with a holographic medium according to one embodiment of the present disclosure.

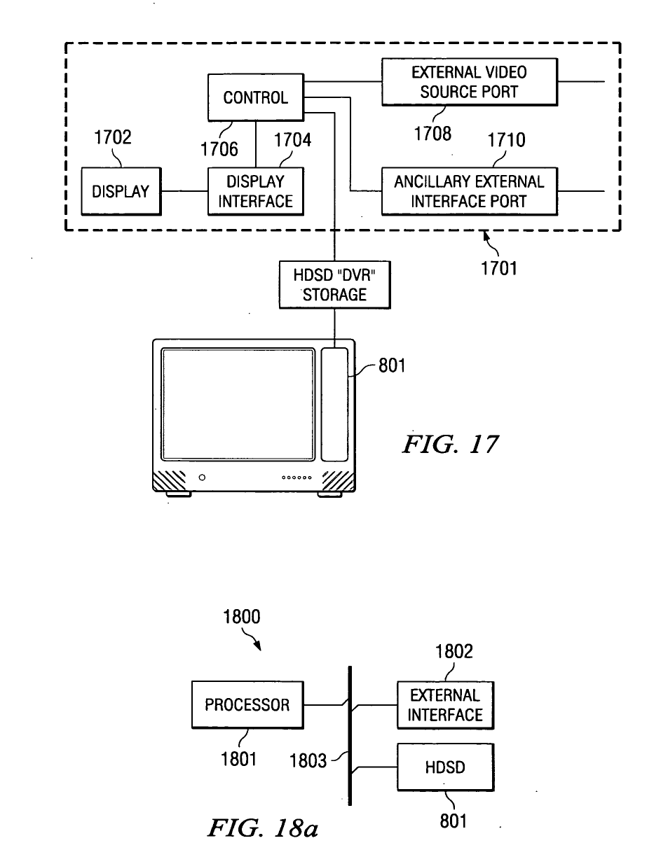

Referring now to FIG. 17, a specific embodiment of 790 may be mounted on the interior, exterior or embedded in the case of a television system. The embodiment can be used by the television for recording and playing back content data that is viewed on the television screen.

Referring now to FIG. 18, a specific embodiment of FIG. 7, block 790 may provide mass storage for an electronic device that is essentially records and plays music. Examples of devices are Apple iPod and MP3 players. The embodiment may provide significant storage of more content and faster random searches of content.

Other examples of specific applications for various embodiments of FIG. 7, block 790 include, but are not limited to still and motion cameras, audio recording devices, digital video recorders, remote controlled vehicles and aircraft, video display devices, video game consoles, and home entertainment equipment.

It will be appreciated by those skilled in the art having the benefit of this disclosure that this invention provides a holographic memory device for use in a personal electronic device. The memory device contains a holographic data storage media adapted to store a data pattern associated with a data beam, means for reading and writing to the holographic data storage media personal electronics device, and a personal electronics device interface for receiving data from and providing data to a host personal electronics device. The means for reading and writing reads and writes data to the holographic data storage media in response to requests received via the personal electronics device interface. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

1. A holographic memory device for use in a personal electronic device comprising:
a holographic data storage media adapted to store a data pattern associated with a data beam;
means for reading and writing to the holographic data storage media personal electronics device; and
a personal electronics device interface for receiving data from and providing data to a host personal electronics device;
wherein the means for reading and writing reads and writes data to the holographic data storage media in response to requests received via the personal electronics device interface.

2. The device of claim 1, wherein the personal electronics device interface is a Universal Serial Bus (USB) interface.

3. The device of claim 1 wherein the means for reading and writing comprise:
a reference beam generator adapted to selectively provide a reference beam to the holographic data storage media; and
a data beam generator adapted to selectively provide a data beam to the holographic storage media;
wherein, during a write operation, the reference beam generator and the data beam generator both operate to provide a reference beam and data beam, respectively, to the holographic storage media.
